(19) United States
(12) Patent Application Publication
(10) Pub. No.: US 2024/0211829 A1
(43) Pub. Date: Jun. 27, 2024

(54) SYSTEM AND METHOD FOR MANAGING ISSUES USING SKILL MATCHING

(71) Applicant: Dell Products L.P., Round Rock, TX (US)

(72) Inventors: ANNE-MARIE MCREYNOLDS, San Jose, CA (US); MING QIAN, Allston, MA (US); CHRISTOPHER O'BRYON HILL, Bellevue, WA (US)

(21) Appl. No.: 18/145,071

(22) Filed: Dec. 22, 2022

(51) Int. Cl. G06Q 10/0631; G06Q 30/015

(52) U.S. Cl. CPC G06Q 10/063112; G06Q 30/015

(57) ABSTRACT

Methods and systems for managing customer-encountered issues are disclosed. To manage the customer-encountered issues, skill levels of service agents assignable to resolve the issues and skills likely to be needed to resolve the issues may be identified to reduce time to resolution. Service agents having levels of skills commensurate with the level of skill likely to be required to resolve the issues may be assigned to resolve the issues. Rather than rigidly defining the skills, the skills may be defined through taxonomic analysis of descriptions of the customer-encountered issues. The taxonomic analysis may be used to identify groupings of previously resolved customer-encountered issues. Each grouping may be treated as requiring a separate skill to resolve the customer-encountered issues that are members of the grouping.

### FIELD

Embodiments disclosed herein relate generally to issue management. More particularly, embodiments disclosed herein relate to systems and methods to manage issues through skill matching.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows, processes, and other aspects of a system in accordance with an embodiment.

FIG. 3A shows a flow diagram illustrating a method of obtaining skill rating for service agents in accordance with an embodiment.

FIG. 3B shows a flow diagram illustrating a method of resolving customer-encountered issues in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing customer-encountered issues. To manage the customer-encountered issues, service requests for the customer-encountered issues may be serviced by service agents. However, the number of service agents may be limited thereby limiting the customer-encountered issues that may be serviced per unit time. If the service agents spend more time resolving issues, fewer customer-encountered issues may be resolved per unit time.

To improve the rate of resolving customer-encountered issues, the service agents may be rated with respect to the ability to skill. However, rather than being explicitly defined, the skills may be defined through taxonomic groupings of customer-encountered issues. The descriptions of the customer-encountered issues may be analyzed to identify terms, and the terms may be used to construct a grouping system based on the taxonomy of the terms, as well as other factors. Customer-encountered issues (and corresponding service requests/tickets to resolve the customer-encountered issues) grouped in a taxonomy group may be treated as having a same root cause.

The service agents may be rated for these root causes linked to the taxonomy groups based on the number of customer-encountered issues in each respective group that the service agent has resolved. In this manner, skills and skill levels may be ascribed to the service agents.

When new customer-encountered issues are identified, a description of the new customer-encountered issue may be analyzed to identify membership in one or more of the taxonomy groups. The new customer-encountered issue may then be ascribed skills corresponding to the taxonomy groups to which member has been ascribed. A service agent have similarly ascribed skill may be assigned to resolve the new customer-encountered issue.

By doing so, a system in accordance with embodiments disclosed herein may reduce the duration of time to resolve customer-encountered issues by improving the likelihood that an assigned service agent has resolved similar customer countered issues in the past. Accordingly, the aggregate quantity of resources expended to resolve issues may be reduced thereby facilitate increase resolution rates of customer-encountered issues.

Thus, embodiments disclosed herein may address the technical problem of resource limitations in response management systems. Due to limited availability of resources, only certain numbers and types of remediation processes may be implemented per unit time. By reducing the time to resolution through improved service agent assignment, the limited quantity of resources may be able to resolve more customer-encountered issues per unit time.

In an embodiment, a method for managing customer-encountered issues is disclosed. The method may include extracting terms from telemetry data for a portion of the customer-encountered issues that were resolved by service agents; obtaining taxonomic groups based on the extracted terms; obtaining skill ratings for the service agents based on the taxonomic groups and the portion of the customer-encountered issues; and assigning a service agent to work a service request for an unresolved customer-encountered issue of the customer-encountered issues based on the skill ratings to resolve the unresolved customer-encountered issue.

Extracting the terms from the telemetry data may include, for a first customer-encountered issue of the portion of the customer-encountered issues: selecting candidate terms from a portion of the telemetry data corresponding to the first customer-encountered issue; obtaining a score for each of the candidate terms based on relevance to an error message indicating the first customer-encountered issue and that triggered initiating of a first service request for the first customer-encountered issue; ranking the candidate terms based on the scores; and selecting a portion of the ranked candidate terms based on a threshold to obtain the terms.

The telemetry data may include the error message and a log documenting operation of a client device that encountered the first customer-encountered issue.

Obtaining the taxonomic groups based on the extracted terms may include conducting a pairwise comparison of the extracted terms to obtain scores for the terms; constructing a tree structure that represents taxonomy of the terms using the scores for the terms; grouping service requests for the customer-encountered issues that were resolved by service agents based on the taxonomy to obtain first groupings of the service requests; identifying second groupings for the service requests based on an automated classification of the service requests; and revising the tree based on a difference between the first groupings and the second groupings to obtain the taxonomic groups.

Obtaining the skill ratings for the service agents based on the taxonomic groups and the portion of the customer-encountered issues may include, for a service agent of the service agents: identifying a first service requests of the service requests resolved by the service agent; assigning a skill to the service agent based on a taxonomic group of the taxonomic groups of which the first service request is a member; and counting a number of a portion of the service requests that were: resolved by the service agent, and members of the taxonomic group; and assigning a level of the skill to the service agent based on the number.

Assigning the service agent may include making a determination regarding whether at least one of the service agents is proficient in resolving the unresolved customer-encountered issue; in an instance of the determination where a portion of the service agents are proficient in resolving the unresolved customer-encountered issue: selecting one of the service agents of the portion of the service agents based on the skill ratings, the selected one of the service agents of the portion of the service agents being assigned to work the service request.

Assigning the service agent may further include identifying a taxonomic group of the taxonomic groups based on a set of terms from a description of the unresolved customer-encountered issue; and identifying the portion of the service agents based on the identified taxonomic group.

A non-transitory media may include instructions that when executed by a processor cause the computer-implemented method to be performed.

A data processing system may include the non-transitory media and a processor, and may perform the computer-implemented method when the computer instructions are executed by the processor.

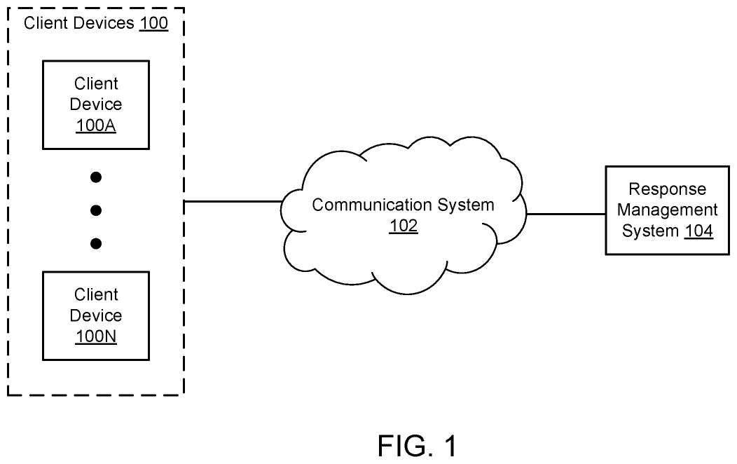

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer-implemented services, the system may include any number of client devices 100. Client devices 100 may provide the computer implemented services to users of client devices 100 and/or to other devices (not shown). Different client devices (e.g., 100A, 100N) may provide similar and/or different computer implemented services.

To provide the computer-implemented services, client devices 100 may include various hardware components (e.g., processors, memory modules, storage devices, etc.) and host various software components (e.g., operating systems, application, startup managers such as basic input-output systems, etc.). These hardware and software components may provide the computer-implemented services via their operation.

To provide certain computer-implemented services, the hardware and/or software components of client devices 100 may need to operate in predetermined manners. If the hardware and/or software components do not operate in the predetermined manners, then a client device may be unable to provide all, or a portion, of the computer-implemented services that it normally provides (and may be expected by the users of the client device to reliably provide).

The hardware and/or software components of client devices 100 may operate differently (e.g., in an undesirable manner) from the predetermined manners for any number of reasons. For example, any of the hardware and/or software components may malfunction. In another example, the hardware and/or software components may be operating nominally but in undesirable manners through various interactions such as resource conflicts or constraints. In a further example, various configuration settings of the hardware and/or software components may be set (intentionally or inadvertently) in a manner that causes the operation of any of client devices 100 to be undesirable. The hardware and/or software components of client devices 100 may operate different from the predetermined manners for other reasons (e.g., various root causes) without departing from embodiments disclosed herein. Thus, a client device may not provide its computer-implemented services for any number of reasons which may be difficult to identify.

The undesired operation of client devices 100 may take any number of forms which may be linked to a root cause of the undesired operation. For example, an undesired operation of a client device may be a lack of operation such as failing to power on when a power button is depressed. In another example, an undesired operation of a client device may be a failure of the client device to utilize a full width of a display when presenting information to a user via the display. In a further example, an undesired operation of a client device may be inconsistent operation of the client device over time such as the client device intermittently freezing for periods of time during which the client device is unresponsive to a user and/or other devices. The undesired operation of client devices 100 may manifest in other manners without departing from embodiments disclosed herein. Thus, a client device may manifest any number of undesired operations which may be due to any number of root causes.

To improve the likelihood of client devices 100 providing desired computer implemented services, the system of FIG. 1 may include response management system (RMS) 104. RMS 104 may be tasked with addressing undesired operation of any of client devices 100. However, RMS 104 may have limited resources with which to address the undesired operation of client devices 100.

In general, embodiments disclosed herein may provide methods, systems, and/or devices for managing undesired operation of client devices 100. To manage the undesired operation of client devices 100, RMS 104 may provide remediation services to address the undesired operation of client devices 100. The remediation services may take into account past attempts at remediating similar issues when deciding on how to use limited resources for resolving client issues.

To take into account past attempts at remediation of similar issues, (i) telemetry data from the devices suffering from the issues may be collected, (ii) the telemetry data may be used to establish groupings of similar issues, and/or (iii) service agents that may attempt to resolve new issues impacting client devices 100 may be ranked based on their past histories of resolving the issues that are members of each of the groupings. When new issues are identified, a service agent may be assigned, at least in part, to resolve the new issue based on their rankings and a classification of the new issue with respect to the groupings.

By leveraging the rankings for the service agents, RMS 104 may marshal its limited resources in a manner that reduces the time to resolve customer-encountered issues (e.g., by assigning service agents with a higher likelihood of resolving the issues) when compared to assignment based on other factors (e.g., availability, workload, etc.).

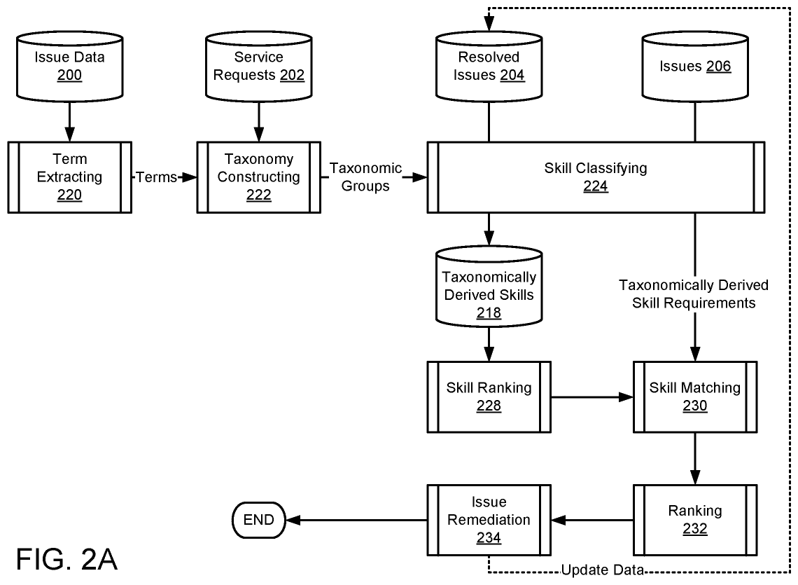

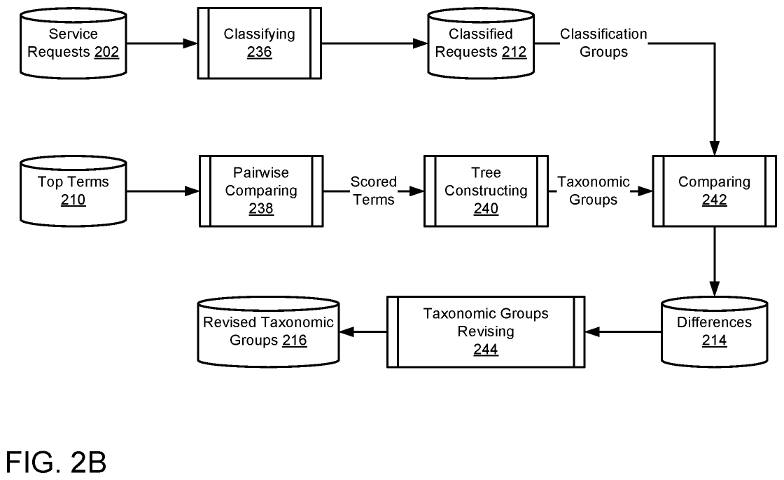

To provide the remediation services, RMS 104 may (i) receive information (e.g., telemetry data such as error alerts, logs that indicate operation of a client device, etc.) from users of client devices 100 regarding various customer-encountered issues (e.g., undesired operation of client devices 100 encountered by users thereof) with respect to client devices 100, (ii) establish service requests based on the customer-encountered issues (the service requests may be tracked using a ticketing system), (iii) establishing and using ranking of service agents to remediate customer-encountered issues, and/or (iv) updating the rankings and information regarding client devices 100 as customer-encountered issues are resolved). Refer to FIGS. 2A-B for additional details regarding obtaining rankings for the service agents and using the rankings to remediate customer-encountered issues.

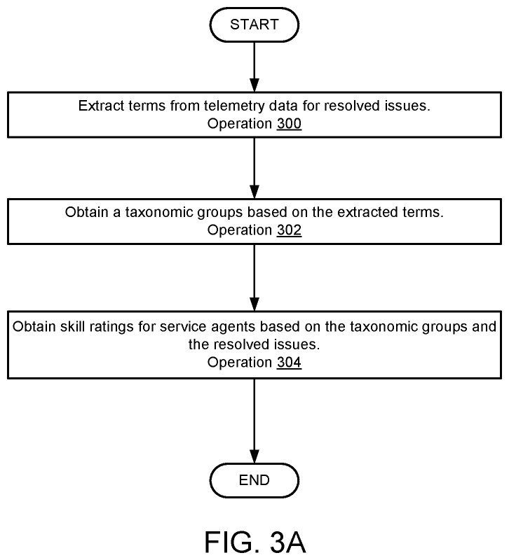

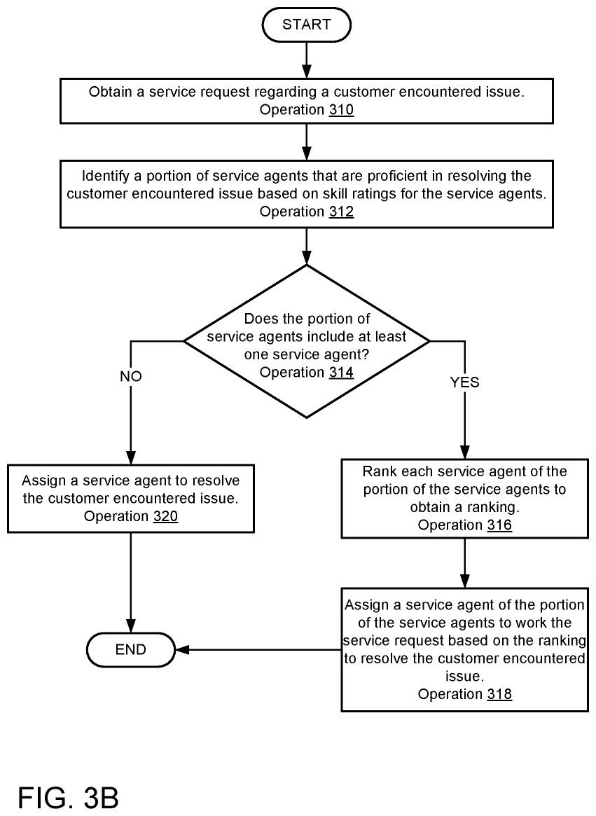

When providing its functionality, RMS 104 may perform all, or a portion, of the methods illustrated in FIGS. 3A-3B.

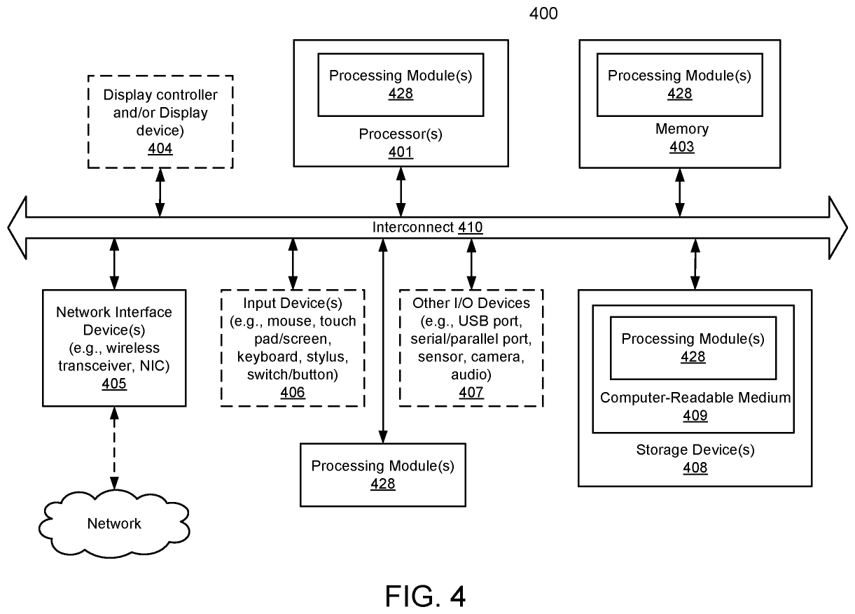

Any of client devices 100 and/or RMS 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

RMS 104 may be implemented with multiple computing devices. The computing devices of RMS 104 may cooperatively perform processes for managing customer-encountered issues. The computing devices of RMS 104 may perform similar and/or different functions, and may be used by different persons that may participate in the management of the customer-encountered issues. For example, RMS 104 may include multiple computing devices used by different service agents (e.g., persons) tasked with resolving customer-encountered issues. The service agents may attempt to utilize knowledge base articles to resolve the customer-encountered issues.

RMS 104 may be maintained, for example, by a business or other entity that has some degree of responsibility with respect to maintaining the operation of client devices 100. For example, RMS 104 may be operated by a business that sells client devices 100 and provides warranty or other types of support for client devices 100 to users and/or owners thereof.

Any of the components illustrated in FIG. 1 may be operably connected to each other (and/or components not illustrated) with communication system 102. In an embodiment, communication system 102 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as included a limited number of specific components, a system in accordance with an embodiment may include fewer, additional, and/or different components than those illustrated therein.

To further clarify embodiments disclosed herein, diagrams illustrating data flows implemented by and data structures used by a system over time in accordance with an embodiment are shown in FIGS. 2A-2B. In FIGS. 2A-2B, data structures are represented using a first set of shapes (e.g., 200-216) and processes are represented using a different set of shapes (e.g., 220-244).

Turning to FIG. 2A, a data flow diagram illustrating data flows, data processing, and/or other operations that may be performed by RMS 104 in accordance with an embodiment is shown.

To manage customer-encountered issues, RMS 104 may identify issues 206. To resolve issues 206, RMS 104 may assign a service agent to work on the issues. RMS 104 may make the assignment based on skill levels for skills ascribed to the service agents and skills believed to be necessary to address the issues.

To identify skills of the service agents and skills necessary to address issues 206, RMS 104 may perform various processes including term extracting 220, taxonomy constructing 222, and skill classifying 224. Each of these processes are discussed below.

Through term extracting 220, historic issues may be analyzed to identify key terms used in the descriptions of the historic issues. To identify the key terms, issue data 200 may be analyzed.

Issue data 200 may include, for example, (i) descriptions of the historic issues, (ii) telemetry data from the client devices that experienced the historic issues, and/or (iii) other types of data regarding the historic issues (e.g., issues that occurred in the past and that have been resolved). The telemetry data may include, for example, logs that include information regarding the operation of a client device (e.g., prior to, during, and/or after an issue arises), error message (e.g., alerts) that indicated that the issue had arose, and/or other types of information regarding the operation of a client device relevant to an issue (e.g., such as descriptions of the issue provided by a user of the client device).

Issue data 200 may be analyzed by identifying candidate terms in the logs and/or alerts (e.g., using natural language processing). The identified candidate terms may then be scored for their relevance to an error message (e.g., that identified the issue). The scoring may be performed via any method.

For example, the scoring may be performed by identifying whether a term appears in a user description of the issue. If the term appears in the description, then the term may be scored based on the number of repetitions of the term in the description of the issue.

Once scored, the candidate terms may be ranked based on the corresponding scores. The scored candidate terms may then be filtered based on a threshold (e.g., minimum score value, number of terms to be included in a set of terms). For example, a fixed number of the top ranked terms may be selected. The selected candidate terms may be used as the terms identified via the process of term extracting 220.

After the terms are identified, taxonomy constructing 222 may be performed to obtain taxonomic groups. Taxonomy constructing 222 may include (i) performing a pairwise comparison of the extracted terms to obtain scores for the terms, (ii) constructing a tree structure (or other structure) based on the scores for the terms, the tree structure representing the taxonomy for the terms (e.g., thereby defining taxonomy groups based on the tree structure, and allowing customer-encountered issues to be classified into one of the taxonomy groups), (iii) classifying previously resolved service requests (e.g., using an auto classifier such as a trained support vector machine) into groups, (iv) comparing the members of the taxonomy groups and the members of the groups defined through classification to identify deltas between these groups, and (v) modifying the taxonomy groups based on the deltas (e.g., to better align with the membership of the groups obtained through classification) to obtain a final set of taxonomy groups. Refer to FIG. 2B for additional details regarding obtaining taxonomic groups.

The taxonomic groups may define groups of previously resolved service requests 202. Each of the taxonomic groups may be treated as having members that all required a same skill to resolve and that is distinguishable from the skill necessary to resolve the service requests of other taxonomic groups.

To establish rating for service agents that resolved the customer-encountered issues (e.g., 204) corresponding to the service requests, skill classifying 224 may be performed. Skill classifying 224 may include (i) categorizing the completed service requests based on the taxonomic groupings, (ii) identifying the service agents that resolved the service requests, and/or (iii) ascribing a skill (e.g., taxonomically derived skills 218) to each service agent that resolved at least one of the service requests in each taxonomic grouping. In other words, each service agent that has resolved a service request in each taxonomic group may be ascribed a skill for the taxonomic group (the skill may not be defined except to the extent that the service agent has experience resolving service requests of the type that are characteristic of the taxonomic group).

For each ascribed skill, skill ranking 228 may be performed to identify a level of the skill that a service agent may have. The level of skill may be identified by, for a skill associated with a taxonomic group, counting the number of service requests that are members of the taxonomic group that the service agent has resolved.

For example, if a first service agent has resolved 3 service requests that are members of a taxonomic group and a second service agent has resolved 1 service request that is a member of the taxonomic group, then both the first service agent and the second service agent may be ascribed the skill associated with the taxonomic group. However, the first service agent may have a skill rating of 3 with respect to the skill and the second service agent may have a skill rating of 1 with respect to the skill (e.g., with larger values indicating higher degrees of proficiency in the skill). This process may be repeated to identify the skills and skill levels for each of the service agents.

After the skills and skill levels are identified, skill classifying 224 may also include classifying new issues 206 into different taxonomic groups. Issues 206 may be classified by identifying the terms in each taxonomic group, identifying terms used to describe issues 206, and classifying issues 206 based on the overlap between the terms in each taxonomic group and the terms used to describe issues 206. The skills (e.g., the “taxonomically derived skill requirements”) associated with any of the taxonomic groups ascribed to an issue may be presumed to be necessary to resolve issues 206.

Once the taxonomically derived skill requirements are identified, skill matching 230 may be performed to identify all of the service agents that have been ascribed skills corresponding to the taxonomically derived skill requirements. These service agents may then be ranked during ranking 232 to obtain an ordering of the service agents with respect to their abilities to resolve the issues. For example, the service agents may be ranked based on their levels of skills for each of the taxonomically derived skill requirements.

The ranking may be based, for example, on the total quantity of skill level of all of the taxonomically derived skill requirements, on an objective function that balances skill level against workload (e.g., based on a quantity of issues 206 assigned to each service agent for resolution and/or other factors to which weight is provided), and/or via other balancing methods.

For example, if an objective function is used, the objective function may weight the skills ascribed to the service agent based on the priority of the terms. The objective function may have a form of f(x1, x2, x3 . . . )=x1*c1+x2*c2 . . . ; where x1 is a level of a skill of the service agent and c1 is a constant used to weight the skill more heavily than the skill represented by x2. The specific weights for the skills may be based on the order of the terms (e.g., provided by term extracting 220) and/or other factors.

Once ranked, a service agent (e.g., the best ranked) may be assigned during issue remediation 234 to resolve each of the issues. Once resolved by the service agents, issue data 200, service requests 202, and resolved issues 204 may be updated to reflect a new level of skill of the service agents.

For example, to update resolved issues 204, update data based on a resolved issue may be obtained and used to update resolved issues. The update data may reflect the outcome of the resolution of a customer-encountered issue. Similarly processes for updating the other data structures may be performed based on issue remediation 234.

In the event that during skill matching 230 no service agent has been ascribed all of the skills to resolve an issue, then other processes for resolving the issue may be implemented. For example, the issue may be placed in a queue serviced by service agents without preference to the service agents that may have superior skill for resolving the issues.

Thus, by implementing the flow shown in FIG. 2A, a system in accordance with embodiments disclosed herein may rate service agents based on skills that are based on taxonomy groupings, and new issues may be prioritized for service based on the taxonomy derived skill likely to be necessary to resolve the service requests.

Turning to FIG. 2B, a data flow diagram illustrating data flows, data processing, and/or other operations that may be performed by RMS 104 in accordance with an embodiment is shown. The processes illustrated in FIG. 2B may be used to obtain taxonomic groupings. FIG. 2B may be an expansion of taxonomy construction 222.

Because of limited descriptions of issues and inherent fallibility of persons attempting to describe the issues, obtaining taxonomic groupings may be challenging. To obtain the taxonomic groupings, two sources of information may be used: (i) the terms used in descriptions of issues and (ii) classifications of resolved service requests. Use of these varying sources of information may improve the reliability of the taxonomic groupings when fallible descriptions of issues are present.

The terms may be used initially to form an initial set of taxonomic groupings. For example, top terms (e.g., a limited set of the terms obtained via term extracting 220 based on a threshold such as a number of terms to be considered) may be subjected to a pairwise comparing 238 process to identify scores for the terms. The pairwise comparison process implemented may be a probabilistic process based on a model. For example, the pairwise comparison process may take into account (i) frequency of occurrence of the terms, (ii) use in sentence structures of descriptions of issue, and/or (iii) other factors that may indicate some terms being of higher likelihood of representing a root cause of an issue.

The scored terms may then drive tree constructing 240 to obtain taxonomic groups. For example, the obtained tree structure may represent the taxonomy of the terms, and the structure of the tree may represent groupings. However, at this stage, due to the limitations with respect to the terms, the taxonomic groupings may be somewhat inaccurate and/or misaligned with the root causes for the issues.

To improve the alignment of the taxonomy with root causes of issues, a separate analysis of service requests 202 may be performed. The analysis may include classifying 236 of the service requests. The classifying may be performed automatically using, for example, a support vector machine, an artificial intelligence model set to classify input (e.g., unsupervised learning processes), and/or via other methods. Classifying 236 may provide classified requests 212. Classified requests may group service requests 202 into groups based on similarity between the service requests. The groups may be referred to as classification groups.

To refine the taxonomic groups, comparing 242 may be performed with respect to classification groups to identify differences 214. Differences 214 may reflect the difference in groupings between classification groups and taxonomic groups. Differences 214 may be used to drive taxonomic groups revising 244 through which the taxonomic groups are modified to better align with the classification groups. The resulting revised taxonomic groups 216 may provide a grouping framework for identifying similar service requests and/or customer-encountered issues, as well as service agents that have experience resolving the customer-encountered issues.

Thus, via the processes illustrated in FIG. 2B, a system in accordance with an embodiment may automatically ascribe skill levels to service agents (e.g., without expressly defining the skills) and identify skill likely to be necessary to resolve tickets.

In an embodiment, RMS 104 is implemented using a hardware device including circuitry. The hardware device may be, for example, a digital signal processor, a field programmable gate array, or an application specific integrated circuit. The circuitry may be adapted to cause the hardware device to perform the functionality of RMS 104 such as term extracting 220, taxonomy constructing 222, skill classifying 224, skill ranking 228, skill matching 230, ranking 232, issue remediation 234, classifying 236, pairwise comparing, tree constructing 240, comparing 242, taxonomic groups revising 244, and/or other processes. RMS 104 may be implemented using other types of hardware devices without departing embodiment disclosed herein.

In one embodiment, RMS 104 is implemented using a processor adapted to execute computing code stored on a persistent storage that when executed by the processor performs the functionality of RMS 104 discussed throughout this application such as term extracting 220, taxonomy constructing 222, skill classifying 224, skill ranking 228, skill matching 230, ranking 232, issue remediation 234, classifying 236, pairwise comparing, tree constructing 240, comparing 242, taxonomic groups revising 244, and/or other processes. The processor may be a hardware processor including circuitry such as, for example, a central processing unit, a processing core, or a microcontroller. The processor may be other types of hardware devices for processing information without departing embodiment disclosed herein.

In an embodiment, RMS 104 includes storage which may be implemented using physical devices that provide data storage services (e.g., storing data and providing copies of previously stored data). The devices that provide data storage services may include hardware devices and/or logical devices. For example, storage may include any quantity and/or combination of memory devices (i.e., volatile storage), long term storage devices (i.e., persistent storage), other types of hardware devices that may provide short term and/or long term data storage services, and/or logical storage devices (e.g., virtual persistent storage/virtual volatile storage).

For example, storage may include a memory device (e.g., a dual in line memory device) in which data is stored and from which copies of previously stored data are provided. In another example, storage may include a persistent storage device (e.g., a solid-state disk drive) in which data is stored and from which copies of previously stored data is provided. In a still further example, storage may include (i) a memory device (e.g., a dual in line memory device) in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data cause the memory device to lose the data).

Storage may also be implemented using logical storage. A logical storage (e.g., virtual disk) may be implemented using one or more physical storage devices whose storage resources (all, or a portion) are allocated for use using a software layer. Thus, a logical storage may include both physical storage devices and an entity executing on a processor or other hardware device that allocates the storage resources of the physical storage devices.

The storage may store data structures including issue data 200, service requests 202, resolved issues 204, issues 206, classified requests 212, differences 243, revised taxonomic groups 216, taxonomically derived skills 218, and/or other data structures. Any of these data structures may be implemented using, for example, lists, tables databases, linked lists, unstructured data, and/or other types of data structures.

As discussed above, the components of FIG. 1 may perform various methods to manage customer-encountered issues. FIGS. 3A-3B illustrate methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of obtaining skill ratings for resolving customer-encountered issues in accordance with an embodiment is shown. The method may be performed by RMS 104 or other components of the system shown in FIG. 1.

At operation 300, terms from telemetry data for resolved issues are extracted. The terms may be extracted, for example, via natural language processing and/or other methods.

At operation 302, taxonomic groups are obtained based on the extracted terms. The taxonomic groups may be obtained by (i) ranking the taxonomic terms based on their relationships to descriptions of the resolved issues, (ii) a set of the ranked taxonomic terms may be selected (e.g., top terms), (iii) the selected taxonomic terms may be compared to one another via probabilistic pairwise comparison to obtain scores for the selected taxonomic terms, (iv) a tree representing the taxonomy of the selected terms may be constructed using the scores for the selected taxonomic terms thereby defining an initial set of taxonomic groups, and/or (v) revision of the taxonomic groups to better align with classifications of the resolved service requests for the resolved issues to obtain a final set of taxonomic groups. The resulting final set of taxonomic groups may group service requests and customer-encountered issues into groups that are likely to have similar root causes.

At operation 304, skill rating for service agents are obtained based on the taxonomic groups and the resolved issues. The skill ratings may be obtained by, for a service agent, identifying the taxonomic groups for which the service agent resolved a service request that is a member of a respective taxonomic group. The service agent may be ascribed a skill associated with each taxonomic group for which the service agent has resolved at least one member service request.

The service agent may also be ascribed a skill level for each skill by counting the number of service requests that are members of the corresponding taxonomic group which the service agent resolved. The number may be the level of the skill for the corresponding taxonomic group.

The method may end following operation 304.

Using the method illustrated in FIG. 3A, a system in accordance with an embodiment may be able to classify (i) skill levels of service agents, and (ii) new issues so that service agents may be assigned to work the new issues based on the skill levels.

Turning to FIG. 3B, a flow diagram illustrating a method of resolving customer-encountered issues in accordance with an embodiment is shown. The method may be performed by RMS 104 or other components of the system shown in FIG. 1.

At operation 310, a service request regarding a customer-encountered issue is obtained. The service requests may be obtained by reading them from storage, receiving them from other devices, and/or by generating them. To generate the service requests, information regarding the customer-encountered issue may be collected (e.g., via a portal and/or other communication medium). The information may be used to generate the service requests via, for example, population of a data structure with the information. The information may include any type and quantity of information regarding the customer-encountered issue, logs, error messages, and/or other types of data structures in which information relevant to resolving the customer-encountered issue may be found. The customer-encountered issue may relate, for example, to a computing device (e.g., any of client devices 100) for which a RMS (e.g., 104) provides management services that may facilitate resolution of the customer-encountered issues.

At operation 312, a portion of service agents that are proficient in resolving the customer-encountered issue are identified based on the skill ratings for the service agents. The portion of the service agents may be identified by (i) identifying one or more of the taxonomic groups to which the customer-encountered issue may below, and (ii) identifying the service agents that are rated as proficient in the skill associated with the identified one or more taxonomic groups.

At operation 314, a determination is made regarding whether the portion of service agents includes at least one service agent. If the portion of service agents includes at least one service agent, then the method may proceed to operation 316 following operation 314. Otherwise, the method may proceed to operation 320 following operation 314.

At operation 316, each of the service agents of the portion of the service agents is ranked to obtain a ranking. The service agents may be ranked based on alignment of their skills with respect to the skills for the taxonomic groups of which the customer-encountered issue is a member. For example, an objective function may be used to calculate a numerical rating for each of the service agents with respect to the customer-encountered issue, and the ratings may be used to define the ranking.

At operation 318, a service agent of the portion of the service agents is assigned to work the service request based on the ranking to resolve the customer-encountered issue. The service agent may be the highest ranked service agent based on the ranking. The service agent may be assigned by, for example, populating a workflow management system or other system with information indicating that the assigned service agent is responsible for resolving the customer-encountered issue.

The assigned service agent may then resolve the customer-encountered issue through various processes (e.g., debugging, analysis, etc.).

The method may end following operation 318.

Returning to operation 314, the method may proceed to operation 320 following operation 314 if the portion of service agents does not include at least one service agent.

At operation 320, a service agent is assigned to resolve the customer-encountered issue. The service agent may be assigned based on a process that does not take into account relative levels of skill in resolving customer-encountered issues. For example, the customer-encountered issue may be placed in a queue serviced by the service agents without regard to alignment between skill and customer-encountered issue, and/or another type of queue serviced based on other metrics.

The method may end following operation 320.

Thus, using the methods illustrated in FIGS. 3A-3B, embodiments disclosed herein may expedite resolution of customer-encountered issues by aligning skills of service agents with skills likely necessary to resolve customer-encountered issues more quickly through taxonomic groupings.

Any of the components illustrated in FIGS. 1-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing customer-encountered issues, the method comprising:
extracting terms from telemetry data for a portion of the customer-encountered issues that were resolved by service agents;
obtaining taxonomic groups based on the extracted terms;
obtaining skill ratings for the service agents based on the taxonomic groups and the portion of the customer-encountered issues; and
assigning a service agent to work a service request for an unresolved customer-encountered issue of the customer-encountered issues based on the skill ratings to resolve the unresolved customer-encountered issue.

2. The method of claim 1, wherein extracting the terms from the telemetry data comprises:
for a first customer-encountered issue of the portion of the customer-encountered issues:
selecting candidate terms from a portion of the telemetry data corresponding to the first customer-encountered issue;
obtaining a score for each of the candidate terms based on relevance to an error message indicating the first customer-encountered issue and that triggered initiating of a first service request for the first customer-encountered issue;
ranking the candidate terms based on the scores; and
selecting a portion of the ranked candidate terms based on a threshold to obtain the terms.

3. The method of claim 2, wherein the telemetry data comprises the error message and a log documenting operation of a client device that encountered the first customer-encountered issue.

4. The method of claim 1, wherein obtaining the taxonomic groups based on the extracted terms comprises:
conducting a pairwise comparison of the extracted terms to obtain scores for the terms;
constructing a tree structure that represents taxonomy of the terms using the scores for the terms;
grouping service requests for the customer-encountered issues that were resolved by service agents based on the taxonomy to obtain first groupings of the service requests;
identifying second groupings for the service requests based on an automated classification of the service requests; and
revising the tree based on a difference between the first groupings and the second groupings to obtain the taxonomic groups.

5. The method of claim 4, wherein obtaining the skill ratings for the service agents based on the taxonomic groups and the portion of the customer-encountered issues comprises:
for a service agent of the service agents:
identifying a first service requests of the service requests resolved by the service agent;
assigning a skill to the service agent based on a taxonomic group of the taxonomic groups of which the first service request is a member; and
counting a number of a portion of the service requests that were:
resolved by the service agent, and
members of the taxonomic group; and
assigning a level of the skill to the service agent based on the number.

6. The method of claim 5, wherein assigning the service agent comprises:
making a determination regarding whether at least one of the service agents is proficient in resolving the unresolved customer-encountered issue;
in an instance of the determination where a portion of the service agents are proficient in resolving the unresolved customer-encountered issue:
selecting one of the service agents of the portion of the service agents based on the skill ratings, the selected one of the service agents of the portion of the service agents being assigned to work the service request.

7. The method of claim 1, wherein assigning the service agent further comprises:
identifying a taxonomic group of the taxonomic groups based on a set of terms from a description of the unresolved customer-encountered issue; and
identifying the portion of the service agents based on the identified taxonomic group.

8. A non-transitory machine-readable medium having instructions stored therein, which when executed by a processor, cause the processor to perform operations for managing customer-encountered issues, the operations comprising:
extracting terms from telemetry data for a portion of the customer-encountered issues that were resolved by service agents;
obtaining taxonomic groups based on the extracted terms;
obtaining skill ratings for the service agents based on the taxonomic groups and the portion of the customer-encountered issues; and
assigning a service agent to work a service request for an unresolved customer-encountered issue of the customer-encountered issues based on the skill ratings to resolve the unresolved customer-encountered issue.

9. The non-transitory machine-readable medium of claim 8, wherein extracting the terms from the telemetry data comprises:
for a first customer-encountered issue of the portion of the customer-encountered issues:
selecting candidate terms from a portion of the telemetry data corresponding to the first customer-encountered issue;
obtaining a score for each of the candidate terms based on relevance to an error message indicating the first customer-encountered issue and that triggered initiating of a first service request for the first customer-encountered issue;
ranking the candidate terms based on the scores; and
selecting a portion of the ranked candidate terms based on a threshold to obtain the terms.

10. The non-transitory machine-readable medium of claim 9, wherein the telemetry data comprises the error message and a log documenting operation of a client device that encountered the first customer-encountered issue.

11. The non-transitory machine-readable medium of claim 8, wherein obtaining the taxonomic groups based on the extracted terms comprises:
conducting a pairwise comparison of the extracted terms to obtain scores for the terms;
constructing a tree structure that represents taxonomy of the terms using the scores for the terms;
grouping service requests for the customer-encountered issues that were resolved by service agents based on the taxonomy to obtain first groupings of the service requests;
identifying second groupings for the service requests based on an automated classification of the service requests; and
revising the tree based on a difference between the first groupings and the second groupings to obtain the taxonomic groups.

12. The non-transitory machine-readable medium of claim 11, wherein obtaining the skill ratings for the service agents based on the taxonomic groups and the portion of the customer-encountered issues comprises:
for a service agent of the service agents:
identifying a first service requests of the service requests resolved by the service agent;
assigning a skill to the service agent based on a taxonomic group of the taxonomic groups of which the first service request is a member; and
counting a number of a portion of the service requests that were:
resolved by the service agent, and
members of the taxonomic group; and
assigning a level of the skill to the service agent based on the number.

13. The non-transitory machine-readable medium of claim 12, wherein assigning the service agent comprises:
making a determination regarding whether at least one of the service agents is proficient in resolving the unresolved customer-encountered issue;
in an instance of the determination where a portion of the service agents are proficient in resolving the unresolved customer-encountered issue:
selecting one of the service agents of the portion of the service agents based on the skill ratings, the selected one of the service agents of the portion of the service agents being assigned to work the service request.

14. The non-transitory machine-readable medium of claim 8, wherein assigning the service agent further comprises:
identifying a taxonomic group of the taxonomic groups based on a set of terms from a description of the unresolved customer-encountered issue; and
identifying the portion of the service agents based on the identified taxonomic group.

15. A data processing system, comprising:
a processor; and
a memory coupled to the processor to store instructions, which when executed by the processor, cause the processor to perform operations for managing remediation of customer-encountered issues, the operations comprising:
extracting terms from telemetry data for a portion of the customer-encountered issues that were resolved by service agents;
obtaining taxonomic groups based on the extracted terms;
obtaining skill ratings for the service agents based on the taxonomic groups and the portion of the customer-encountered issues; and
assigning a service agent to work a service request for an unresolved customer-encountered issue of the customer-encountered issues based on the skill ratings to resolve the unresolved customer-encountered issue.

16. The data processing system of claim 15, wherein extracting the terms from the telemetry data comprises:
for a first customer-encountered issue of the portion of the customer-encountered issues:
selecting candidate terms from a portion of the telemetry data corresponding to the first customer-encountered issue;
obtaining a score for each of the candidate terms based on relevance to an error message indicating the first customer-encountered issue and that triggered initiating of a first service request for the first customer-encountered issue;
ranking the candidate terms based on the scores; and
selecting a portion of the ranked candidate terms based on a threshold to obtain the terms.

17. The data processing system of claim 16, wherein the telemetry data comprises the error message and a log documenting operation of a client device that encountered the first customer-encountered issue.

18. The data processing system of claim 15, wherein obtaining the taxonomic groups based on the extracted terms comprises:
conducting a pairwise comparison of the extracted terms to obtain scores for the terms;
constructing a tree structure that represents taxonomy of the terms using the scores for the terms;
grouping service requests for the customer-encountered issues that were resolved by service agents based on the taxonomy to obtain first groupings of the service requests;
identifying second groupings for the service requests based on an automated classification of the service requests; and
revising the tree based on a difference between the first groupings and the second groupings to obtain the taxonomic groups.

19. The data processing system of claim 16, wherein obtaining the skill ratings for the service agents based on the taxonomic groups and the portion of the customer-encountered issues comprises:
for a service agent of the service agents:
identifying a first service requests of the service requests resolved by the service agent;
assigning a skill to the service agent based on a taxonomic group of the taxonomic groups of which the first service request is a member; and
counting a number of a portion of the service requests that were:
resolved by the service agent, and
members of the taxonomic group; and
assigning a level of the skill to the service agent based on the number.

20. The data processing system of claim 17, wherein assigning the service agent comprises:
making a determination regarding whether at least one of the service agents is proficient in resolving the unresolved customer-encountered issue;
in an instance of the determination where a portion of the service agents are proficient in resolving the unresolved customer-encountered issue:
selecting one of the service agents of the portion of the service agents based on the skill ratings, the selected one of the service agents of the portion of the service agents being assigned to work the service request.
